(19) United States
(12) Patent Application Publication
(10) Pub. No.: US 2018/0344084 A1
(43) Pub. Date: Dec. 6, 2018

(54) PAN FOR ROASTING TOMATOES

(71) Applicant: LUIS GUILLERMO LOPEZ, LOMPOC, CA (US)

(72) Inventor: LUIS GUILLERMO LOPEZ, LOMPOC, CA (US)

(21) Appl. No.: 15/615,447

(22) Filed: Jun. 6, 2017

(51) Int. Cl. A47J 37/06

(52) U.S. Cl. CPC A47J 37/0611; A47J 37/06

(57) ABSTRACT

A tomato roaster for roasting tomatoes may include a lower plate with at least one lower tomato indentation; a handle extending from the lower plate; and an upper plate designed to mate with the lower plate, the upper plate including at least one upper tomato indentation positioned to align with the at least one lower tomato indentation, wherein the at least one lower tomato indentation and the at least one upper tomato indentation align to create a tomato cavity sized to accommodate a tomato.

### BACKGROUND

The embodiments herein relate generally to cooking, and more particularly, to a pan for roasting tomatoes.

Roasting tomatoes can be time consuming. Moreover, the conventional methods can result in unevenly roasted tomatoes.

Therefore, what is needed is a device to roast tomatoes more evenly and more efficiently.

### SUMMARY

Some embodiments of the present disclosure include a tomato roaster for roasting tomatoes. The tomato roaster may include a lower plate with at least one lower tomato indentation; a handle extending from the lower plate; and an upper plate designed to mate with the lower plate, the upper plate including at least one upper tomato indentation positioned to align with the at least one lower tomato indentation, wherein the at least one lower tomato indentation and the at least one upper tomato indentation align to create a tomato cavity sized to accommodate a tomato.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present disclosure, shown in use.

FIG. 2 is a top perspective view of one embodiment of the present disclosure.

FIG. 3 is a bottom perspective view of one embodiment of the present disclosure.

FIG. 4 is an exploded view of one embodiment of the present disclosure.

FIG. 5 is a section detail view of one embodiment of the present disclosure, taken along line 5-5 in FIG. 1.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to roast tomatoes and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Upper Plate

2. Lower Plate

3. Handle

4. Tomato Cavity

The various elements of the device of the present disclosure may be related in the following exemplary fashion. It is not intended to limit the scope or nature of the relationships between the various elements and the following examples are presented as illustrative examples only.

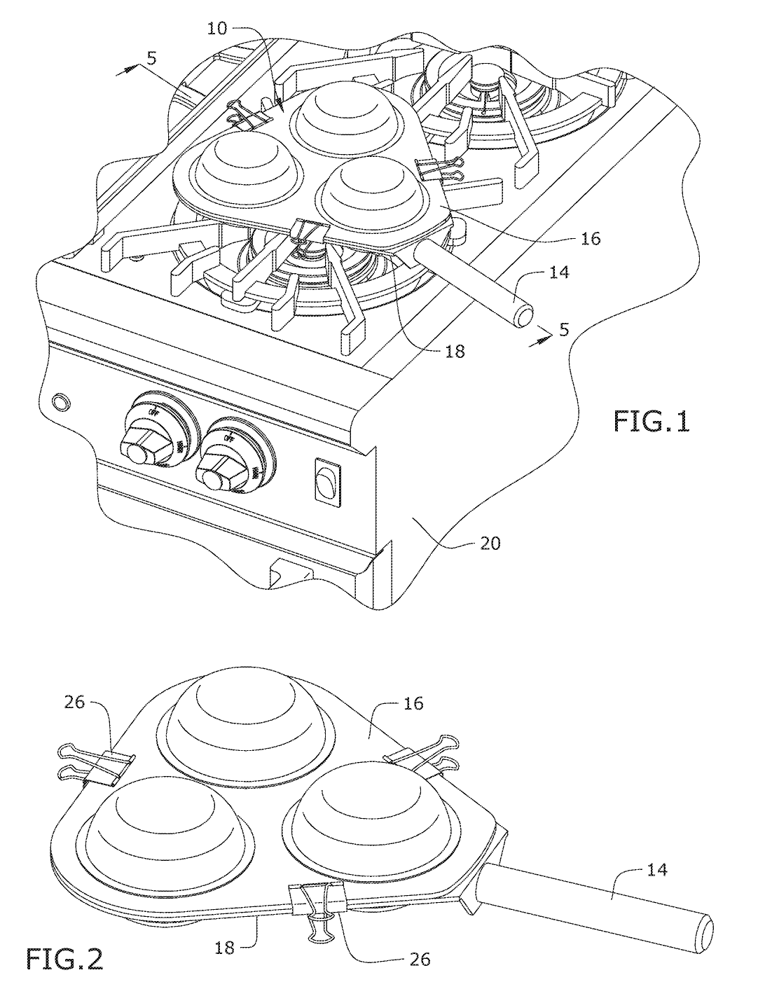

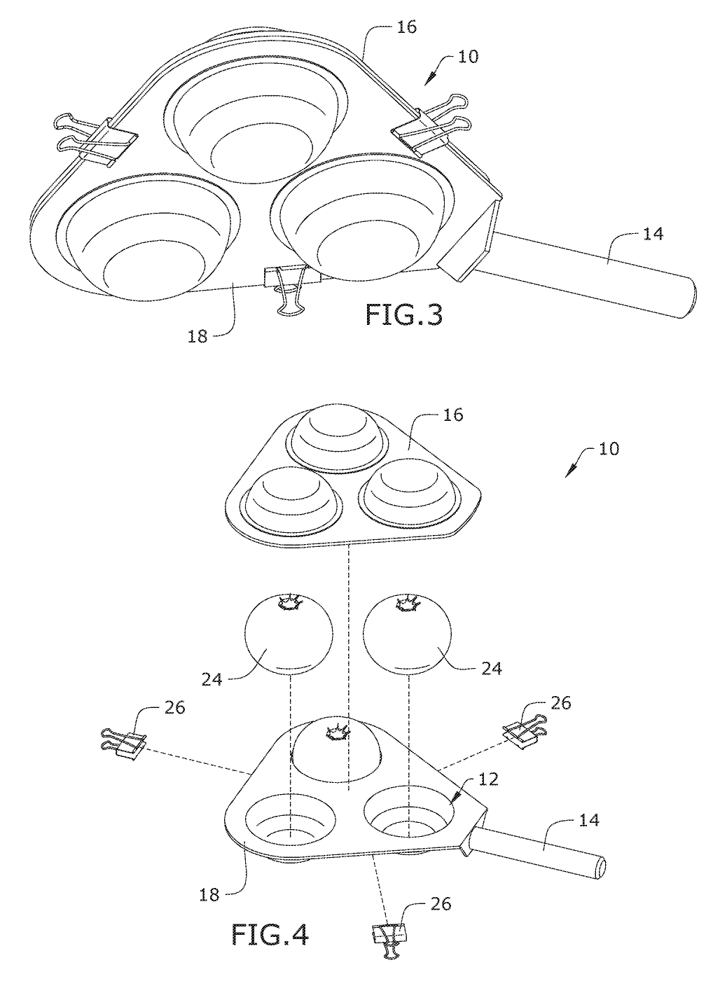

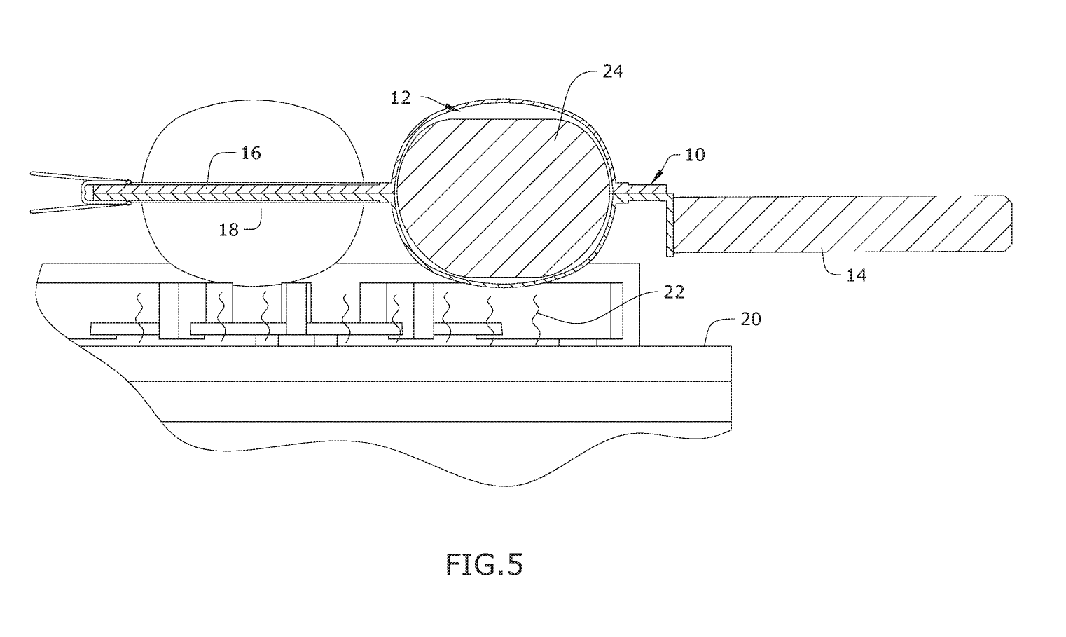

By way of example, and referring to FIGS. 1-5, some embodiments of the present disclosure include a tomato roaster 10 for roasting tomatoes 24, the tomato roaster 10 comprising a lower plate 18 with at least one lower tomato indentation; a handle 14 extending from the lower plate 18; and an upper plate 16 designed to mate with the lower plate 18, the upper plate 18 comprising at least one upper tomato indentation positioned to align with the at least one lower tomato indentation, wherein the at least one lower tomato indentation and the at least one upper tomato indentation align to create a tomato cavity 12 sized to accommodate a tomato 24. The tomato roaster 10 may also comprise locks designed to secure the upper plate 16 to the lower plate 18. For example, as shown in the Figures, the locks may comprise clamps 26 spaced along an outer edge of the tomato roaster 10.

As shown in the Figures, some embodiments of the tomato roaster 10 may comprise more than one tomato cavity 12, such as about 3 tomato cavities 12. In fact, the tomato roaster 10 may comprise any desired number of tomato cavities 12, for example from about 1 tomato cavity 12 to about 10 tomato cavities 12. In any instance, the tomato cavities 12 may be evenly distributed about the tomato roaster 10 such that, when heat 22 is applied, the heat 22 is evenly distributed to the tomatoes 24 in the tomato cavities 12. The overall shape of the tomato roaster 10 may vary to accommodate the desired number of tomato cavities 12.

In some embodiments, an outer edge of the lower plate 18 and/or the upper plate 16 may comprise a raised lip, wherein the lip may help prevent unwanted spillage onto the heat source 20 during use.

The tomato roaster 10 may be made of any suitable materials for making cooking tools, such as stainless steel. In some embodiments, the tomato roaster 10 may be made of a nonstick material or may include a nonstick coating on surfaces of the tomato roaster 10 designed to contact the tomatoes 24.

The use the tomato roaster 10 of the present disclosure, a user may place a tomato 24 in each tomato cavity 12 and secure the upper plate 16 to the lower plate 18 using the lock. The tomato roaster 10 may then be placed on a heat source, such as a stove 20, and the heat 22 may be turned on to a medium heat. The tomato roaster 10 may be heated for about 3 to about 4 minutes on the first side, flipped over, and heated for an additional about 2 to about 3 minutes. The tomato roaster 10 may then be removed from the heat source and allowed to cool for about 5 to about 8 minutes before opening.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A tomato roaster for roasting tomatoes, the tomato roaster comprising:
a lower plate with at least one lower tomato indentation; and
an upper plate designed to mate with the lower plate, the upper plate comprising at least one upper tomato indentation positioned to align with the at least one lower tomato indentation,
wherein the at least one lower tomato indentation and the at least one upper tomato indentation align to create a tomato cavity sized to accommodate a tomato.

2. The tomato roaster of claim 1, further comprising at least one lock designed to secure the upper plate to the lower plate.

3. The tomato roaster of claim 2, wherein the at least one lock comprises a clamp.

4. The tomato roaster of claim 1 comprising from about 1 tomato cavity to about 10 tomato cavities.

5. The tomato roaster of claim 1 comprising multiple tomato cavities, wherein the tomato cavities are evenly distributed among a size of the tomato roaster.

6. The tomato roaster of claim 1, further comprising a handle extending from the lower plate.
